(19) United States
(12) Patent Application Publication
(10) Pub. No.: US 2001/0032812 A1
(43) Pub. Date: Oct. 25, 2001

(54) System and method to improve flotation systems

(76) Inventors: Dwain E. Morse, Santa Barbara, CA (US); Wade O. Morse, Yorba Linda, CA (US); Thomas G. Matherly, Lompoc, CA (US); Eddie Dean Hendrickson, Chatsworth, CA (US)

Correspondence Address: Scott W. Kelley, KELLY BAUERSFELD LOWRY & KELLEY, LLP, Suite 1650, 6320 Canoga Avenue, Woodland Hills, CA, 91367, US

(21) Appl. No.: 09/759,669

(22) Filed: Jan. 12, 2001

Related U.S. Application Data
(60) Provisional application No. 60/176,358, filed on Jan. 13, 2000.

(51) Int. Cl. B01D 17/038

(52) U.S. Cl. 210/257.1; 210/198.1; 210/512.1

(57) ABSTRACT

A separation system is disclosed for use with a treatment tank, such as a flotation or decant tank, to separate particles and/or gases from a liquid stream. The system is coupled to a liquid source comprising a suspension solution. The system includes a hydrocyclone system that directs the solution stream through a first chamber or passage in a generally helical fashion along a cylindrical wall where bubbles-to-particle aggregates are formed and chemicals can be mixed and activated. A second chamber encloses the outlet of the hydrocyclone and may take many forms, including a generally concentric or parabolic form, and acts to decelerate the liquid and deliver the liquid to a third chamber from which bubbles escape the liquid. The liquid drops from the third chamber into the treatment tank in a manner which only minimally disturbs the liquid already in the tank.

### RELATED APPLICATION

This application claims priority from provisional application Ser. No. 60/176,358, filed Jan. 13, 2000.

### BACKGROUND OF THE INVENTION

The invention relates to liquid conditioning flotation separation components, systems and methods. More particularly, the present invention relates to liquid conditioning components, systems and methods that may be retrofit into existing flotation, clarification, and decant tanks to improve the separation of particulate matter from carrier liquid streams.

Dissolved air flotation (DAF) systems are often used to separate particulate material and gases from solutions such as wastewater. The systems typically employ the general principle that bubbles rising through a solution attach to and carry away particles suspended in the solution. Similarly, gases dissolved in the solution diffuse into the bubbles. As bubbles reach the surface of the solution, the attached particles coalesce to form a froth or floc that is easily collected while the entrapped gases within the bubble dissipate into the air. Thus, a DAF must accomplish two main steps when particle removal is the goal: 1) get bubbles to contact and stick to particles (agglomerate), and 2) provide an environment that allows the agglomerations to float to a surface where they collect and can be removed.

Traditional DAF systems typically introduce small air bubbles into the lower portion of a relatively large tank filled with the usually aqueous liquid to be treated. While such systems work for their intended applications, the processing time and particle/gas removal efficiency typically varies directly with the residence time of the bubbles in the solution. The residence time, in turn, varies directly with turbulence and depth of the bubbles in the solution, and inversely with bubble buoyancy. As a result, traditional DAF systems employ relatively large, deep and costly tanks having correspondingly large “footprints”. The footprints maximize the gas transfer time from the solution into the bubbles. The depth maximizes the probability that particles will contact the bubbles during the residence time available within the tank. Moreover, the relatively large footprints also allow the bubbles sufficient time to float to the surface.

In an effort to reduce the tank size for a DAF system, one proposal disclosed in U.S. Pat. No. 4,022,696 employs a rotating carriage and floc scoop. The carriage directs an inlet solution substantially horizontally along a flow path to increase the path length for bubble travel, and correspondingly increases the residence time. Unfortunately, while the tank size reduction is alleged as an advantage, the problem with performance tied to residence time still remains. This is due in part to turbulence created by the rotating carriage and scoop.

Another proposal, disclosed in U.S. Pat. No. 5,538,631, seeks to address the turbulence problem by incorporating a plurality of spaced apart and vertically arrayed baffles. The baffles include respective vanes angularly disposed to re-direct the flow of liquid from an inlet positioned at the bottom of the tank. Liquid flowing through the tank deflects upwardly as it traverses the vanes, allegedly reducing the extent and intensity of turbulence generated near the inlet to the tank.

While this proposal alleges to reduce the turbulence and thereby the bubble residence time, the redirected liquid still appears to affect bubbles rising in other areas of the tank, and influences the residence time of such bubbles. Moreover, the proposal fails to solve the basic problem of DAF performance being dependent on bubble residence time.

In an effort to overcome the limitations in conventional DAF systems, those skilled in the art have devised air-sparged hydrocyclones (ASH) as a substitute for DAF systems. One form of air sparged hydrocyclone is disclosed by Miller in U.S. Pat. No. 4,279,743. The device typically utilizes a combination of centrifugal force and air sparging to remove particles from a liquid stream. The stream is fed under pressure into a cylindrical chamber having an inlet configured to direct the liquid stream into a generally helical path along a porous wall. The angular momentum of the liquid generates a radially directed centrifugal force that varies directly with the liquid velocity and indirectly with the radius of the helical path. The porous wall is contained within a gas plenum having gas pressurized to permeate the porous wall and overcome the opposing centrifugal force acting on the liquid.

In operation, the Miller ASH receives and discharges the rapidly circulating solution while the air permeates through the porous wall. Air bubbles that emit from the wall are sheared into the liquid stream by the rapidly moving liquid flow. Micro-bubbles formed from the shearing action combine with the particles or gases in the solution and float them toward the center of the cylinder as a froth in a vortex. In this way, the step of bubble-particle agglomeration is accomplished in less than a second inside the hydrocyclone before the stream reaches a downstream tank. The centrally located froth vortex is then captured and exited through a vortex finder disposed at the upper end of the cylinder while the remaining solution exits the bottom of the cylinder. However, the ASH creates and does not neutralize turbulence, which slows the rise of the bubble-particle agglomerations. In addition, the ASH does not have the ability to use existing tankage to effect separation rapidly. In summary, the ASH cannot deposit conditioned water into existing tankage in a manner that does not introduce turbulence that slows bubble rise.

Waste and process water treatment frequently involves adding polymers to the stream. Polymers are long chain molecules. This aspect makes them effective at joining with contaminants in the stream to ferry them out. Unfortunately, the long molecular chain nature of polymer molecules results in molecular damage under established mixing methods. In particular, the molecules are broken when subject to stresses such as shear. Damaged molecules do not function as well, necessitating increases in dosage. As dosage increases, polymer usage, and hence cost, are increased. A way is needed to add polymers to liquid streams without damaging the polymers.

In addition, polymer molecule charges tend to be “self-satisfying”, which means that positive charges at one site tend to pair with negative charges elsewhere along the length. This causes the molecule to twist into a knot. In this coiled form, the charge sites of the polymer molecule are much less available for connecting with contaminants in the stream and the polymer is less effective, again necessitating higher dosing. Established methods for uncoiling polymers include pH adjustment. A non-chemical method to accomplish the same thing would reduce or obviate the need for chemicals.

Existing DAF systems require mixing tanks for polymers, surfactants, and other substances that are used to create flocs. They also require a high pressure, compressed air system for adding air to the tank. The mixing tanks and compressed air systems are bulky, and compressed air systems tend to be maintenance-, energy-, noise- and leak-intensive.

Existing conditioning tanks, for example, flotation, clarification, and decant tanks, are not designed for use with ASH devices or other liquid cyclones. Consequently, the advantages of the ASH and fluid cyclones in general are not harvested. Instead, compressed air systems are used to create bubble-particle aggregates, separate mixing tanks are used for additives, including additives that are made less effective by shear forces present in established types of mixers. In addition, the established mixing methods do not uncoil polymeric additives, leaving charge sites unavailable to contaminants in the stream. Thus, in order to incorporate the advantages of a fluid cyclone, an interface designed to receive fluid from the source of the stream, add and mix additives to the stream, and deliver fluid ready for flotation from the cyclone device is required.

Accordingly, there is a need for an economical flotation separation system which unites liquid cyclone technology with conventional conditioning tanks for the purpose of enhancing flotation and particulate separation in those conventional tanks. Moreover, a need exists for a flotation separation system which can be efficiently attached and plumbed into existing conditioning tanks. The flotation separation system of the instant invention satisfies these needs and provides other related advantages.

### SUMMARY OF THE INVENTION

The liquid conditioning system of the present invention provides an efficient and cost-effective way of treating solutions by maximizing particle-bubble contact upstream of the conventional conditioning tanks and converting an existing treatment tank to a separation chamber. The system is designed for simple attachment to existing conditioning tanks, and increases throughput and speed of treatment.

To realize the advantages above, the invention, in its concentric form, comprises a liquid conditioning system that includes a hydrocyclone defining a cylindrical treatment environment. The cylindrical environment forms a passage or chamber defined by a cylindrical inner wall with an accelerator head at its upstream inlet end and an outlet at its lower downstream end. The accelerator head is coupled to a solution source for receiving a liquid stream and directing it through the passage in a generally helical fashion along the cylindrical inner wall. The head includes a vent to gas, such as atmospheric air. The system further includes a second chamber concentrically disposed about the hydrocyclone, and which is in liquid communication with the lower end of the hydrocyclone. Thus, the helically flowing liquid is received in the second chamber, which redirects the flow upwards and opens to the surface of a third chamber. Large entrained bubbles, which would create turbulence in the downstream quiescent zone if allowed to remain entrained in the stream, escape from the surface of the third chamber, which is open to atmosphere. From the third chamber, the stream flows downward through a passage that penetrates the surface of liquid in an existing treatment tank. Thus, the liquid entry is submerged. The system can be attached externally to an existing treatment tank or submersed directly into the same.

In yet another form, the unit fits on the side of an existing treatment tank. This embodiment is referred to in this application as the “Parabolic Second Chamber Embodiment”. The upwardly opening second chamber of the invention is rectangular and contains a substantially parabolic or otherwise curved wall to direct liquid flow with minimal turbulence from the hydrocyclone outlet upward to the third chamber. This embodiment includes an energy dissipation sloped ramp, pocket and a false floor within the tank to reduce existing tank depth (which reduces hydrostatic pressure and bubble rise time), and a flexible baffle to divide the existing treatment tank into a turbulent zone and a quiescent zone.

In an embodiment in which one or more liquid additives are added to the stream, the invention includes one or more inlets for injecting one or more chemicals additives, for example, a liquid polymer, into the liquid stream to be treated. The inlets are preferably disposed in the accelerator head. For liquid polymers, the preferable location for the inlets is in the accelerator head at least 180 degrees downstream from the inlet of the liquid to be treated along the path of the liquid.

In a group of embodiments in which one or more gases, including atmospheric air, are added to the stream, the hydrocyclone is designed to inject gas into the solution passing through the vessel. The hydrocyclone may include an inlet in its accelerator head, which may introduce gas into the liquid solution as the liquid solution passes through it. Alternatively, the hydrocyclone could be gas-sparged using a porous tube or the like through which gas is sparged into the liquid to be treated as it passes through the hydrocyclone.

In yet another form, bubbles are induced into the liquid to be treated by partially starving the hydrocyclone of air or other gas. Small bubbles needed for flotation are induced by partially closing the vent in the head of the hydrocyclone. The result is closing of the helical flow of liquid into a vortex. The air in the space above the vortex (upstream) is at pressure lower than atmospheric pressure. Exposure of the liquid to be treated to pressures below atmospheric induces small bubbles to form from gas already dissolved in the liquid. Thus, bubbles needed for flotation are created without gas-sparging, which obviates the need for a regulated pressurized source of gas (e.g. air blower), a gas plenum, and a porous tube. In addition, more bubbles are created in this partially air-starved mode than would be present in the prior art wherein the hydrocyclone is vented to the atmosphere.

In yet another form, the liquid to be treated is subjected to very low pressures. The vent in the head of the hydrocyclone is either absent or closed to atmosphere, which closes the helical flow into a vortex. Bubbles are created from gas already dissolved in the water coming into contact with the near-vacuum area inside the vortex formed by the liquid. As in the induced air embodiment above, no gas sparging is used, obviating the need for a regulated pressurized source of gas (e.g. air blower), a gas plenum, and a porous tube. In addition, more bubbles are created in this partially air-starved mode than would be present in the prior art wherein the hydrocyclone is vented to the atmosphere or other gas source.

Thus, the present invention in one illustrative embodiment is directed to a system for receiving liquid from a liquid source and separating particulate matter from the liquid, including a hydrocyclone in communication with the liquid source, the hydrocyclone being configured to pass the liquid therethrough in a generally helical manner, the hydrocyclone further including means to inject liquid or gaseous additives, the hydrocyclone further including an outlet; a second chamber disposed about the hydrocyclone and in liquid communication with the outlet of the hydrocyclone, the secondary chamber including an open upper end; a third chamber above the second, the third chamber including an outlet directed downward to the treatment tank.

Other features and advantages of the present invention will be apparent from the following detailed description when read in conjunction with the accompanying drawings, which illustrate, byway of example, the principles of the invention.

### BRIEF DESCRIPTION OF THE DRAWINGS

The accompanying drawings illustrate the invention. In such drawings:

FIG. 1 is a vertical cross-sectional view of a Concentric embodiment of the present invention;

FIG. 2A is a top plan view of the system of FIG. 1 through cross-section A-A;

FIG. 2B is a top plan view of the system of FIG. 1 through cross-section B-B;

FIG. 3 is a cross-sectional view of a Parabolic Second Chamber embodiment of the present invention;

FIG. 4 is a top plan view of the Parabolic Second Chamber embodiment of FIG. 3;

FIG. 5 is a cross-sectional view of an adjustable ramp system of the Parabolic Second Chamber embodiment of FIG. 3;

FIG. 6A is a cross-sectional view of a hydrocylone portion of the system under typical gas-sparging; and

FIG. 6B is a cross-sectional view of the hydrocylone portion of the system when subjected to reduced pressure.

### DETAILED DESCRIPTION OF THE INVENTION

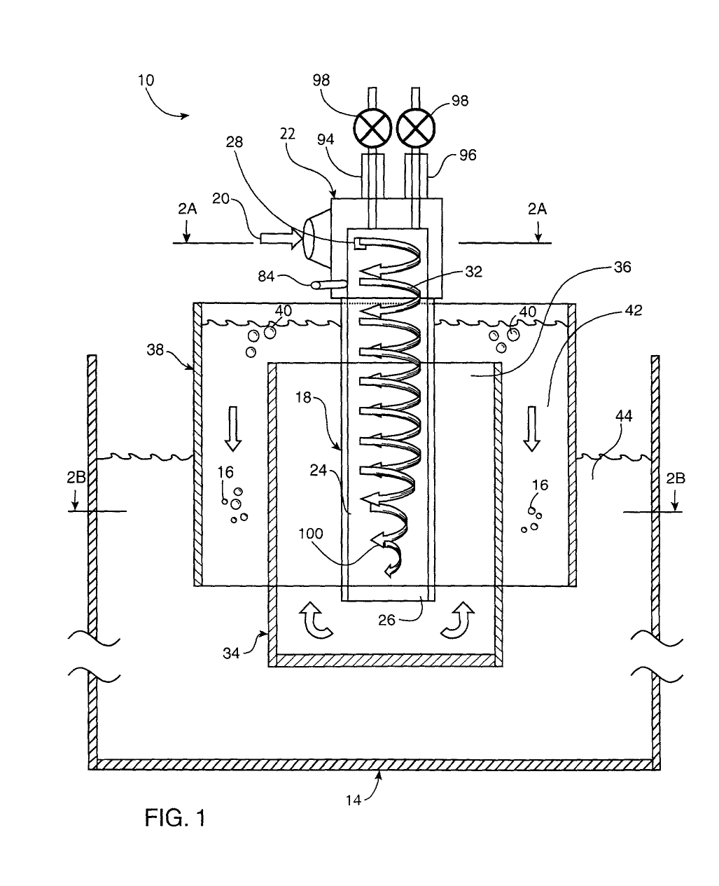

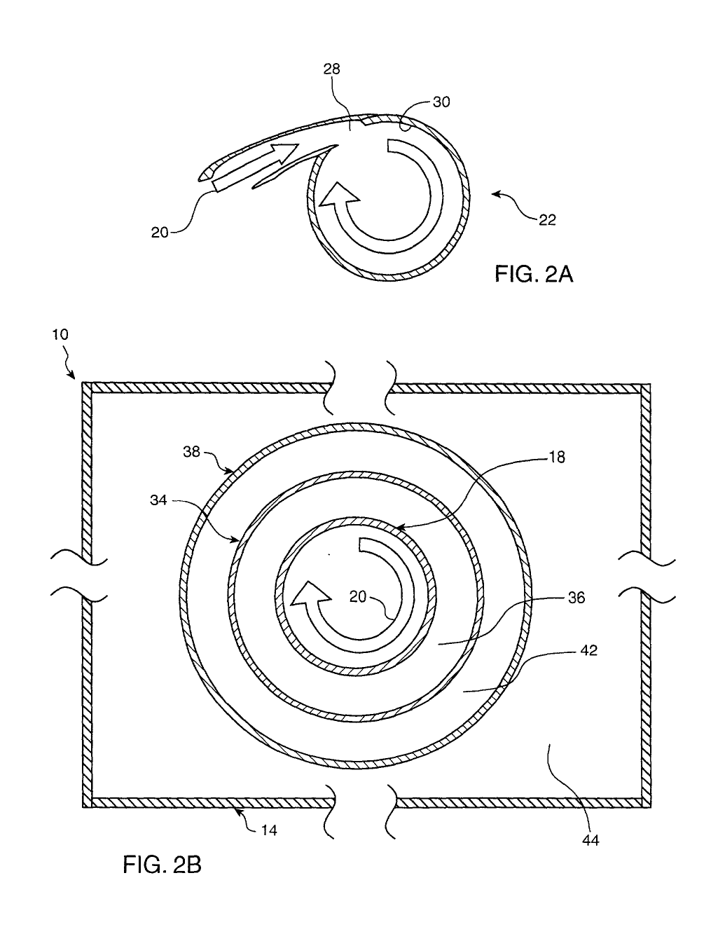

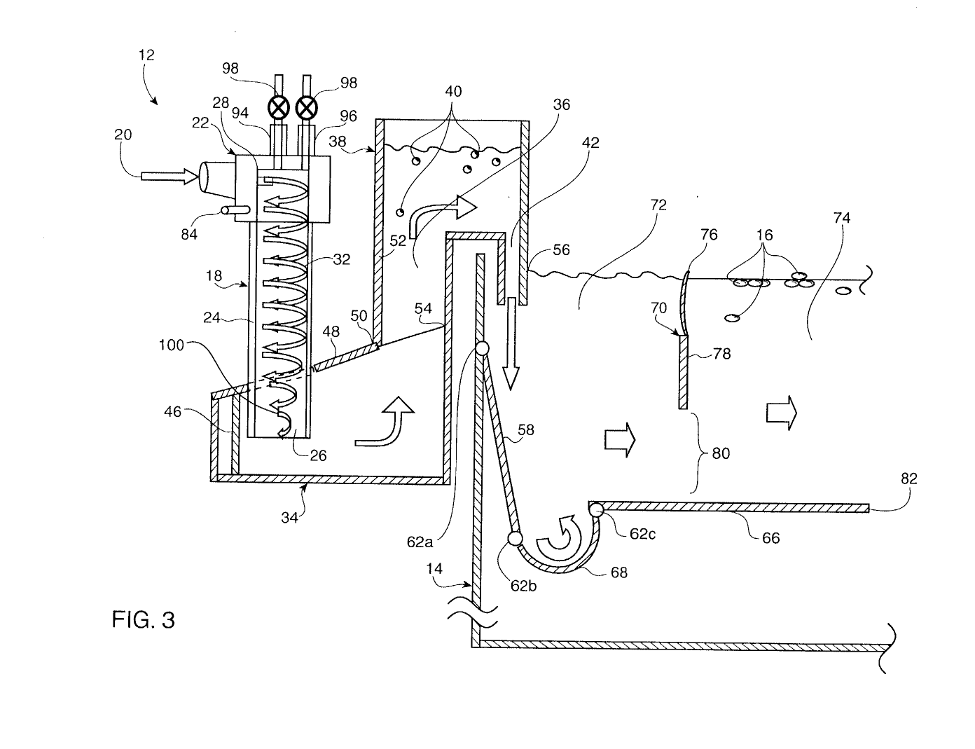

Referring now to the FIGURES a liquid conditioning system of the present invention, generally designated by the reference number 10 in FIGS. 1 and 2, and by the reference number 12 in FIGS. 3-5, is shown. The system is designed to condition water or other liquids and to deliver conditioned liquid to virtually any form of existing or new liquid treatment tank 14, such as a flotation, clarification, or decant tank, where the conditioned liquid may settle and bubble-particulate aggregates 16 in the liquid may rise to the top of the tank 14 and be removed from the top of the tank 14 in any well known manner.

The systems 10 and 12 include, generally, a hydrocyclone 18 to receive liquid 20 from a liquid source and create a bubble-rich environment for a high incidence of bubble-particle collisions and gas transfer from the liquid to the bubbles. Liquid to be treated 20 is provided to the system by any suitable pump. The liquid 20 enters the system 10 or 12 at accelerator 22. The hydrocyclone 18 has a cylindrical inner wall 24 which creates a passage or chamber with an outlet 26.

The accelerator 22, frequently a Kreb's head, accelerates the flow of the liquid 20 into the hydrocyclone 18. The liquid 20 is preferably delivered to the hydrocyclone 18 through an inlet 28 in the accelerator 22. The accelerator 22 has a cylindrical interior. The inlet 28 has a rectangular cross section and is arranged to deliver the liquid 20 in a generally tangential direction relative to the inner wall 30 of accelerator 22 and at a relatively high speed. As is well known, such delivery causes the liquid 20 to flow in the above-described helical manner 32 through the hydrocyclone 18. During the liquid stream's passage through the hydrocyclone 18, bubbles attach to particles and the first step of flotation separation is completed.

### A. Concentric Embodiment

Referring now to FIGS. 1 and 2, the system 10 includes a second chamber 34 which encloses the outlet 26 of the hydrocyclone 18 in a generally concentric manner and which is in liquid communication with the outlet 26. The outlet 26 of the hydrocyclone 18 opens into the bottom of the second chamber 34 which receives liquid 20 that now contains bubble-particle aggregates 16. The second chamber 34 opens upwardly at a top portion thereof into outlet area 36, and directs the liquid upwardly to a third chamber 38 positioned above the second chamber 34 and disposed in a generally concentric relation about the outlet 36 of the second chamber 34. The third chamber 38 is generally open to the atmosphere. Alternatively, third chamber 38 can be closed to the atmosphere and ducted to a gas gathering system if gas in the liquid is to be harvested or treated. In the third chamber 38, large bubbles 40 escape the stream and so are not carried into the existing treatment tank 14 downstream where they would create turbulence and thereby interfere with the rise of bubble-particle aggregates 16.

The stream descends from third chamber 38 through an area 42 defining an outlet which surrounds second chamber 34 and passes downward through the free surface of the liquid 44 in the existing treatment tank 14. As it passes through area 42, the liquid stream makes a submerged entry into the body of the existing treatment tank 14. Preferably, the area 42 is elevated with respect to the bottom of tank 14 so that the bubble-particulates have a relatively short travel path to the free liquid 44 surface, minimizing the time needed to place the particles at the surface where they can be skimmed off.

The system 10 may be disposed within the existing treatment tank 14 such that the hydrocyclone 18, second chamber 34, and third chamber 38 components are deployed inside the walls of treatment tank 14. Alternatively, the system 10 may be otherwise connected to the tank 14 for liquid communication between the system 10 and the tank 14.

### B. Parabolic Second Chamber Embodiment

Referring now to FIGS. 3-5, a Parabolic Second Chamber Embodiment is disclosed. For this embodiment, attached to the bottom of the upwardly opening second chamber 34 is a substantially curved wall such as the illustrated parabolic wall 46. It is to be understood that the parabolic wall 46 can also be designed to form the second chamber 34. The open end of the substantially parabolic wall 46 faces generally horizontally toward the upwardly directed outlet 36 of the second chamber 34 so as to direct the flow smoothly from the hydrocyclone 18 out of the upwardly opening second chamber 34. By smoothing the corners of second chamber 34, the substantially parabolic wall 46 reduces shear forces on the bubble-particle and polymer-particle aggregates 16 and minimizes their breakage. The substantially parabolic wall 46 extends upward from the floor of the upwardly opening second chamber 34 around the outside of the bottom of hydrocyclone 18. The wall 46 wraps closely, preferably within an inch, from the outside of the hydrocyclone 18 outlet 26. The bottom of the hydrocyclone 18 is preferably between 1 and 5 inches above the bottom of the upwardly opening second chamber 34.

Referring to FIG. 3, the top of the substantially parabolic wall 46 joins the upper surface 48 of the upwardly opening second chamber 34. At the corner 50 where the top surface 48 of second chamber 34 turns upward to form an adjacent wall 52 of third chamber 38, the substantially parabolic wall 46 continues to the far wall 54 of second chamber 34 to at least partially define the outlet 36 of the second chamber 34.

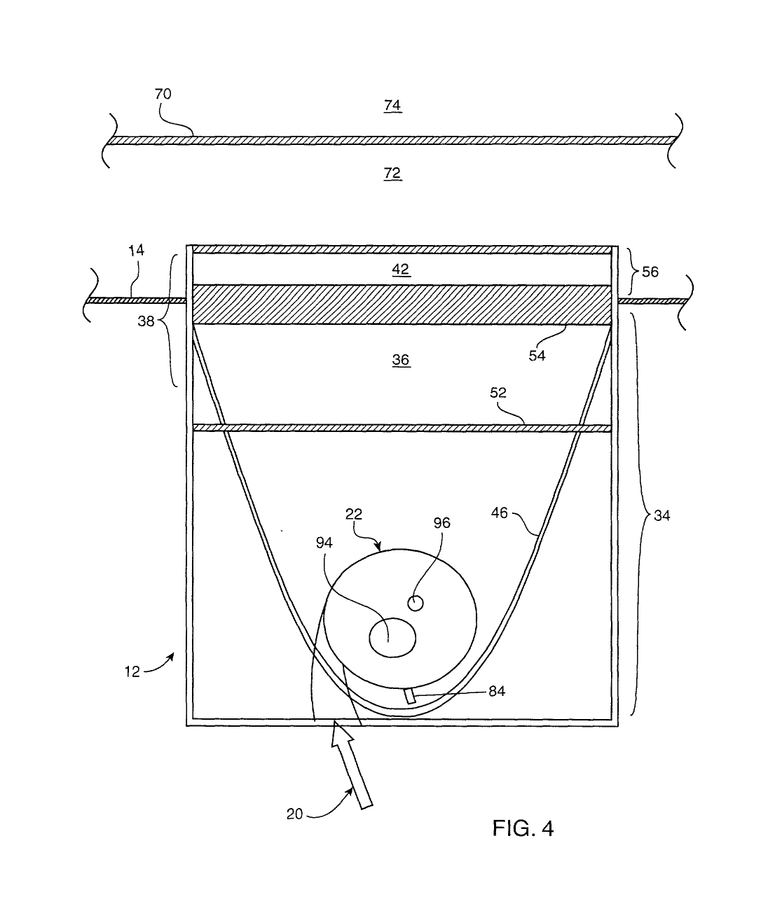

With continuing reference to FIGS. 3 and 4, liquid flows through area 36 upward to the third chamber 38. As in the third chamber 38 of the Concentric Embodiment, large bubbles 40 escape the liquid stream 20. The liquid flows across the third chamber 38 to a vertical chute 56 which directs the liquid down into the existing treatment tank 14. The chute 56 preferably has a narrow rectangular horizontal cross-section. The short axis of the rectangle is preferably between 1/4 and 1 inch in length; the exact distance increased with liquid flow rate. Further, this distance can be varied depending on the embodiment. The chute 56 passes through the liquid surface of the existing treatment tank 14 and the liquid 20 flows by gravity into the treatment tank 14. The chute 56 essentially hooks over the side of the existing treatment tank 14 (e.g. DAF tank) but other means of attachment are possible. Thus, this embodiment is well suited for retrofitting existing DAF or other treatment tanks 14.

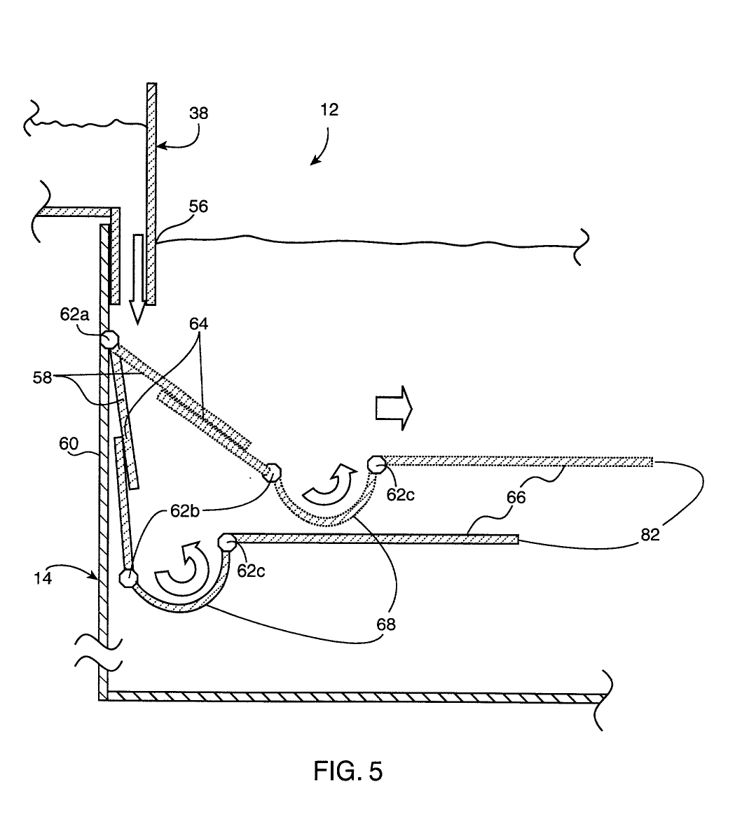

With reference now to FIGS. 3 and 5, an entry ramp 58 is mounted against the wall 60 of the existing treatment tank 14 and under chute 56. The entry ramp 58 may include hinges 62a and 62b which allow the angle and height of the entry ramp 58 relative to the treatment tank 14 wall 60 to be adjusted. In addition, the length of ramp 58 is adjustable using a joint 64 wherein two sections of the ramp 58 slide past one another.

This embodiment may include a false floor 66 which is horizontally oriented above the bottom of existing treatment tank 14. The false floor 66 serves to reduce the bubble rise distance to the surface of the liquid (which reduces the amount of time needed to float particles out). A hinge 62c between a pocket 68 and the false floor 66 allow the false floor 66 to be maintained in a substantially level orientation. Together, the hinges 62a, 62b and 62c are used to adjust the positions of ramp 58, pocket 68 and false floor 66 to smoothly channel liquid from the chute 56 into the energy dissipating pocket 68, avoid existing skimmer paddles and the like within the existing treatment tank 14, and to obtain the proper depth of the liquid relative to the established liquid height within the tank 14. FIG. 5 shows two positions of the ramp 58, pocket 68 and floor 66; the dashed representations of these structures show a sample second position.

A baffle 70 divides the tank 14 into a turbulent zone 72 and a quiescent zone 74. Turbulence of the liquid stream dissipates above the pocket 68 in the turbulent area 72. In this manner, the liquid from system 20 creates minimal disturbance to the fluid already in the tank 14. The baffle 70 is preferably comprised of a water impermeable material. In applications where the treatment tank 14 has skimmers that would get caught or be disrupted by a rigid baffle, a flexible baffle 76, preferably 3 to 7 inches tall, extends above the surface of the fluid and extends beneath its surface to a rigid baffle 78 to which it is attached. The flexible baffle 76 and the rigid baffle 78 act to separate the tank into a turbulent zone 72, where the kinetic energy from the drop through chute 56 dissipates before the liquid 20 flows into the quiescent zone 74. Less turbulence allows more rapid rise of the bubble particulate aggregate 16 for the purpose of skimming. In addition, the rigid baffle 78 defines the top of a gap 80 through which the liquid flows into the quiescent zone 74.

The false floor 66 may extend underneath part of both the turbulent 72 and quiescent 74 zones. Between the false floor 66 and the rigid baffle 78 the gap 80 directs the flow of the liquid stream 20 into the quiescent zone 74. The gap 80 is preferably between 3 inches and 8 inches tall depending upon liquid stream throughput. The false floor 66 has a downstream edge 82 that is preferably between 18 inches and 4 feet from the hinge 62c.

In either of the above embodiments, to enhance particle separation, a liquid additive, preferably a polymer, may be added to the helical flow in the accelerator 22. The hydrocyclone 18 includes an inlet 84 which may be used for injecting surface chemistry, such as liquid or solid coagulant agents, flocculent agents, polymer compounds, or chemical catalysts to reduce and reverse the attraction of the particles to the liquid and increase particle-to-particle attractions or liquid-phobic interfaces.

The additive inlet 84 is preferably disposed in the accelerator head 22 downstream of the upper end of the first cylindrical wall 30. In the preferred embodiment, the additive inlet 84 is disposed, for polymers, at least 180 degrees of a turn of the liquid stream 20 around the inside of the cylindrical wall 30 downstream from the inlet 28 into the accelerator head 22. Additive inlet 84 is typically sufficiently downstream of the stream inlet 28 to avoid the inlet 28-related pressure drop and shear forces that would damage the polymer molecules and render the polymer less effective. The inlet 84 may be perpendicular to the wall 24 of the hydrocyclone 18 or it may be at an acute angle to the flow of the stream inside the hydrocyclone 18. Alternatively, inlet 84 may be used for liquid chemical injection and located in the top of the accelerator 22. Injected in these configurations and locations, the liquid additive is swept into the helical flow 32 and mixed with the liquid stream 20 with a minimum of shear force.

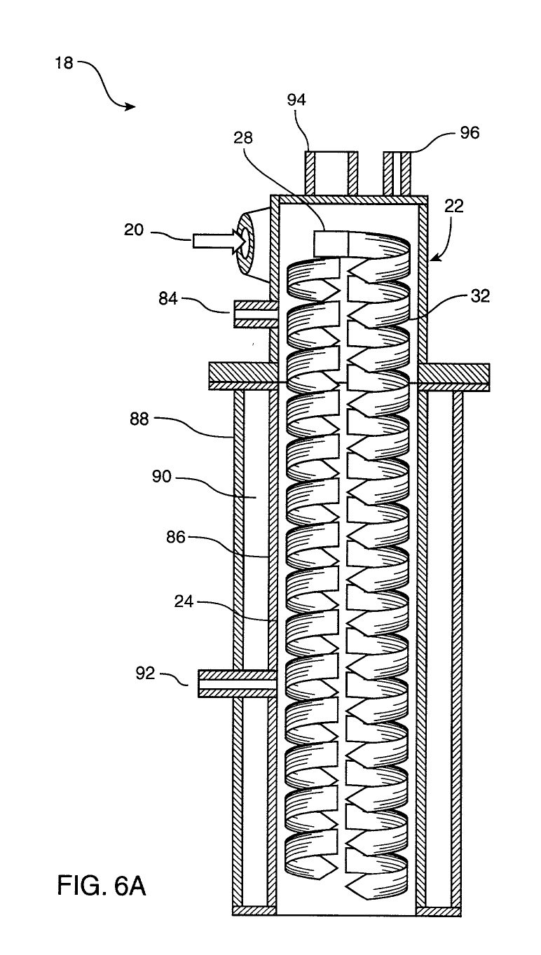

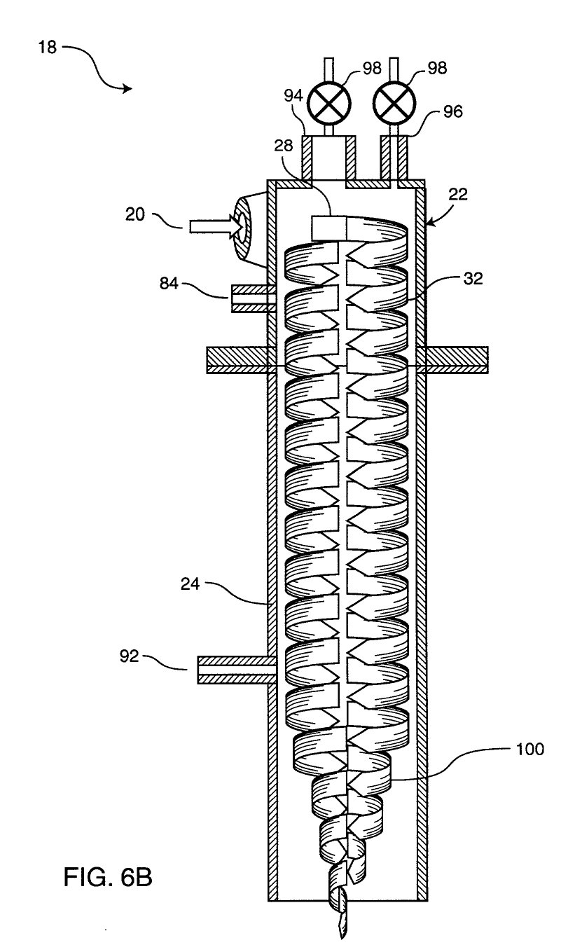

Alternatively, or additionally, a gaseous additive (or additives) may be added into the helical flow inside the hydrocyclone 18. Gas bubbles such as air, ozone, or chlorine are injected into the liquid 20 by the hydrocyclone 18 through gas inlet 92 or valve 98 and gas inlet 96 of FIG. 6B.

The hydrocyclone 18 may be in the form of a modified air-sparged hydrocyclone (ASH), as disclosed in U.S. Pat. No. 4,279,743 or other form of liquid cyclone capable of infusing a large quantity of air or gas bubbles into a helically flowing liquid. The disclosure of U.S. Pat. No. 4,279,743 is expressly incorporated herein by reference for these purposes.

Referring to FIG. 6A, when the hydrocyclone 18 is a gas-sparged hydrocyclone, it typically includes a cylindrical containment vessel having an open ended porous tube 86 formed of a gas-permeable material. The porous tube 86 includes a cylindrical interior wall 24 defining an inner liquid passage with respective inlet and outlet openings. An enlarged cylindrical hollow housing 88 is disposed concentrically around the porous tube 86 to form an annular plenum 90 enclosing the porous tube 86. The plenum 90 includes a gas inlet 92 coupled to a source of regulated pressurized air or gas. When the hydrocyclone 18 is air-sparged, the source of air is a blower that generates between 2 and 10 psi at the outer surface of the porous tube 86. The shearing action of the high velocity solution passing by the pores in the interior wall of the porous tube 86 creates bubbles ranging from sub-micron to several hundred microns in size. The head 22 is vented to atmosphere by an opening 94 at between 10 and 25 percent of the diameter of the inner cylindrical wall 24 of the hydrocyclone 18.

Alternatively, a gaseous additive may be added through an inlet 96 in the accelerator 22. A source of pressurized regulated gas can be attached in any suitable manner at inlet 96 and fed into the less-than-atmospheric pressure area inside the vortex. The inlet 96 would be equipped with a valve 98 suitable for adjusting flow of the gas. For example, CO₂ can be added in this way to reduce the pH of the liquid stream 20.

Referring to FIG. 6B, bubbles can be induced from the liquid rather than created only by turbulence. A liquid cyclone 18 can be used without sparging air or a gas through the helical liquid flow 32. In particular, the hydrocyclone 18 can be starved of air or other gas at the upstream end by partially closing the vent 94 using any suitable valve 98. The liquid 20 flowing through the hydrocyclone 18 then creates a low pressure area inside the liquid helix 32, and the helical flow 32 closes into a liquid vortex 100 at the downstream end of the hydrocyclone 18. The vortex 100 encloses a space not occupied by liquid and the pressure in this area is less than atmospheric pressure. To create bubbles for particle flotation, the system then relies either on bubbles created from air or gas drawn into the system through vent 94 by the partial vacuum associated with the liquid vortex 100 or on the air or gas dissolved in the liquid before it enters the hydrocyclone 18. In this way, bubbles are induced in the liquid stream. In any case, the relative velocities of particles and bubbles is preferably on the order of approximately one meter per second, which creates a substantial likelihood that bubbles and particles will collide to form an aggregate 16.

The vortex of liquid may be closed to form an area of near vacuum. A liquid cyclone 18 can be used without sparging air or a gas through the helical liquid flow. In particular, the helix 32 of the stream flow inside the hydrocyclone 18 is closed into a vortex 100 at the downstream end of the hydrocyclone 18. This is accomplished by closing to the atmosphere the vent 94 in the accelerator head 22 of the hydrocyclone 18. The vent 94 is closed using the valve 98. Alternatively, the hydrocyclone could simply lack a vent 94 and valve 98. The helical flow away from the head reduces the pressure inside the vortex 100 to pressures closer to vacuum than to atmospheric pressure. Gases such as CO₂ introduced into the interior of the vortex and controlled by a valve at inlet 96 in the accelerator 22 reduce the pH of the liquid without the need for chemical mixing tanks.

To create bubbles for particle flotation, the system then relies on the near vacuum conditions inside the vortex to create bubbles from air or gas present within the liquid before it enters the hydrocyclone 18. In any case, the relative velocities of particles and bubbles is preferably on the order of approximately one meter per second, which creates a substantial likelihood that bubbles and particles will collide to form an aggregate 16.

It will be understood by those having skill in the art that the system 10 or 12 of the present invention may be used in connection with an existing treatment tank 14, and can be easily connected to the tank 14 without requiring any puncturing of the existing tank. Alternatively, the system 10 or 12 may be incorporated into an entirely new water treatment system including a new tank 14.

Those skilled in the art will appreciate the advantages afforded by the present invention. Of particular significance is the capability of retrofitting existing treatment tanks 14 to become more efficient in removing particulates from a liquid, while at the same time not requiring any modifications to the existing tank 14. Additionally, by introducing the conditioned liquid to the tank 14 near the surface of the tank, the bubble-particulate composites 16 have a relatively short travel path to the free liquid surface, which minimizes the time needed to place the particles at the surface where they can be skimmed off. Thus, bubble residence time is effectively reduced, the flotation process is faster, and system throughput thereby increases.

Although several embodiments have been described in detail for purposes of illustration, various modifications may be made without departing from the scope and spirit of the invention. Accordingly, the invention is not to be limited, except as by the appended claims.

What is claimed is:

1. A system for receiving liquid from a liquid source and separating particulate matter from the liquid, the system comprising:
a hydrocyclone in communication with the liquid source, the hydrocyclone being configured to pass the liquid therethrough in a generally helical manner, the hydrocyclone defining a first chamber including an inlet adapted to receive liquid and an outlet;
a second chamber disposed about the hydrocyclone and in liquid communication with the outlet of the hydrocyclone, the second chamber configured to channel the liquid to an open upper end of the second chamber defining an outlet;
a third chamber positioned above the second chamber and in liquid communication with the outlet of the second chamber, the third chamber configured to channel the liquid into a downwardly directed outlet of the third chamber; and
a tank having fluid therein, the tank in communication with the outlet of the third chamber and operative to receive the liquid from the third chamber outlet below the surface of the tank fluid.

2. The system of claim 1, wherein the hydrocyclone is gas-sparged.

3. The system of claim 1, wherein the hydrocyclone includes at least one inlet adapted for injecting a chemical additive into the liquid.

4. The system of claim 1, wherein the inlet to the hydrocyclone comprises an accelerator head having an opening of rectangular cross-section directed tangentially relative to an inner wall of the accelerator head.

5. The system of claim 4, including an inlet for liquid chemical injection located in the hydrocyclone accelerator head such that the inlet injects chemicals through the accelerator wall at least 180 degrees of one full turn of the liquid path downstream of the entry of the liquid into the accelerator head.

6. The system of claim 4, wherein the accelerator head is configured to introduce one or more gaseous or liquid chemicals through a top portion thereof and into the hydrocyclone.

7. The system of claim 1, wherein the hydrocyclone includes a valve which allows selective entry of gas into the interior of the hydrocyclone.

8. The system of claim 7, wherein the valve is capable of being partially or completely closed to gas-starve the hydrocyclone and convert the helix liquid flow into a vortex liquid flow.

9. The system of claim 1, wherein the second chamber is disposed in a generally concentric relation about the outlet of the hydrocyclone and the third chamber is disposed in a generally concentric relation to the second chamber.

10. The system of claim 9, wherein the hydrocylone, second chamber and third chamber are at least partially immersed in the fluid in the tank.

11. The system of claim 1, wherein the second chamber includes a parabolic wall substantially enclosing the outlet of the hydrocyclone that channels the flow of the liquid to the outlet of the second chamber.

12. The system of claim 11, including a chute extending from the outlet of the third chamber and configured to deliver the liquid from the outlet into the tank below the surface of the fluid therein.

13. The system of claim 12, wherein the hydrocyclone, the second chamber, the third chamber and the chute are mounted to the tank such that the chute extends into the fluid of the tank adjacent a wall thereof.

14. The system of claim 13, including an entry ramp disposed below the chute and attached to the wall of the tank, and a false floor disposed adjacent to the ramp below the surface of the fluid in the tank.

15. The system of claim 14, including a curved pocket member interconnected between the ramp and the false floor.

16. The system of claim 15, wherein the ramp, the pocket member, and false floor are adjustable relative to the tank.

17. The system of claim 14, wherein the tank includes a baffle positioned above the false floor and extending upwardly above the surface of the fluid in the tank, the baffle dividing the tank into a turbulent zone and a quiescent zone while allowing liquid in the tank to flow beneath the baffle from the turbulent zone and into the quiescent zone.

18. The system of claim 17, wherein the baffle comprises a lower rigid portion and an upper flexible portion extending from the rigid portion to above the surface of the fluid in the tank.

19. A system for receiving liquid from a liquid source and separating particulate matter from the liquid, the system comprising:
a hydrocyclone in communication with the liquid source, the hydrocyclone being configured to pass the liquid therethrough in a generally helical manner; the hydrocyclone defining a first chamber including an inlet adapted to receive the liquid and an outlet;
a second chamber disposed in a generally concentric relation about the outlet of the hydrocyclone and in liquid communication with the outlet of the hydrocyclone, the second chamber configured to channel the liquid to an open upper end of the second chamber defining an outlet;
a third chamber positioned above the second chamber and disposed in a generally concentric relation about the outlet of the second chamber and in liquid communication with the outlet of the second chamber, the third chamber configured to channel the liquid into a downwardly directed outlet thereof; and
a tank having fluid therein and in communication with the outlet of the third chamber and operative to receive the liquid from the third chamber outlet below the surface of the tank fluid;
wherein the hydrocyclone, second chamber and third chamber are at least partially immersed in the tank.

20. The system of claim 19, wherein the hydrocyclone is gas-sparged.

21. The system of claim 19, wherein the hydrocyclone includes at least one inlet adapted for injecting a chemical additive into the liquid.

22. The system of claim 19, wherein the inlet to the hydrocyclone comprises an accelerator head having an opening of rectangular cross-section directed tangentially relative to an inner wall of the accelerator head.

23. The system of claim 22, including an inlet for liquid chemical injection located in the hydrocyclone accelerator head such that the inlet injects chemicals through the accelerator wall at least 180 degrees of one full turn of the liquid path downstream of the entry of the liquid into the accelerator head.

24. The system of claim 22, wherein the accelerator head is configured to introduce one or more gaseous or liquid chemicals through a top portion thereof and into the hydrocyclone.

25. The system of claim 19, wherein the hydrocyclone includes a valve which allows selective entry of gas into the interior of the hydrocyclone.

26. The system of claim 25, wherein the valve is capable of being partially or completely closed to gas-starve the hydrocyclone and convert the helix liquid flow into a vortex liquid flow.

27. A system for receiving liquid from a liquid source and separating particulate matter from the liquid, the system comprising:
a hydrocyclone in communication with the liquid source, the hydrocyclone being configured to pass the liquid therethrough in a generally helical manner; the hydrocyclone defining a first chamber including an inlet adapted to receive the liquid and an outlet;
a second chamber having a parabolic wall substantially enclosing the outlet of the hydrocyclone and in liquid communication with the outlet of the hydrocyclone, an open side of the substantially parabolic wall at least partially defining an upwardly directed outlet of the second chamber;
a third chamber disposed above the outlet of the second chamber and in liquid communication with the outlet of the second chamber, the third chamber being operative to receive liquid from the second chamber and allow bubbles to escape the liquid;
a chute extending from a downwardly directed outlet of the third chamber; and
a tank having fluid therein and in fluid communication with the chute and operative to receive the liquid from the chute below the surface of the tank fluid.

28. The system of claim 27, wherein the hydrocyclone is gas-sparged.

29. The system of claim 27, wherein the hydrocyclone includes at least one inlet adapted for injecting a chemical additive into the liquid.

30. The system of claim 27, wherein the inlet to the hydrocyclone comprises an accelerator head having an opening of rectangular cross-section directed tangentially relative to an inner wall of the accelerator head.

31. The system of claim 30, including an inlet for liquid chemical injection located in the hydrocyclone accelerator head such that the inlet injects chemicals through the accelerator wall at least 180 degrees of one full turn of the liquid path downstream of the entry of the liquid into the accelerator head.

32. The system of claim 30, wherein the accelerator head is configured to introduce one or more gaseous or liquid chemicals through a top portion thereof and into the hydrocyclone.

33. The system of claim 27, wherein the hydrocyclone includes a valve which allows selective entry of gas into the interior of the hydrocyclone.

34. The system of claim 33, wherein the valve is capable of being partially or completely closed to gas-starve the hydrocyclone and convert the helix liquid flow into a vortex liquid flow.

35. The system of claim 27, wherein the hydrocyclone, the second chamber, the third chamber and the chute are mounted to the tank such that the chute extends into the fluid of the tank adjacent a wall thereof.

36. The system of claim 35, including an entry ramp disposed below the chute and attached to the wall of the tank, and a false floor disposed adjacent to the ramp below the surface of the fluid in the tank.

37. The system of claim 36, including a curved pocket member interconnected between the ramp and the false floor.

38. The system of claim 37, wherein the ramp, the pocket member, and false floor are adjustable relative to the tank.

39. The system of claim 36, wherein the tank includes a baffle positioned above the false floor and extending upwardly above the surface of the fluid in the tank, the baffle dividing the tank into a turbulent zone and a quiescent zone while allowing liquid in the tank to flow beneath the baffle from the turbulent zone and into the quiescent zone.

40. The system of claim 39, wherein the baffle comprises a lower rigid portion and an upper flexible portion extending from the rigid portion to above the surface of the fluid in the tank.
